(19) United States
(12) Patent Application Publication
(10) Pub. No.: US 2022/0111750 A1
(43) Pub. Date: Apr. 14, 2022

(54) DISASTER-STRICKEN AREA SPECIFICATION DEVICE, DISASTER-STRICKEN AREA SPECIFICATION PROGRAM, AND DISASTER-STRICKEN AREA SPECIFICATION SYSTEM

(71) Applicant: TOYOTA JIDOSHA KABUSHIKI KAISHA, Toyota-shi (JP)

(72) Inventors: Yoshimasa WATANABE, Sunto-gun (JP); Kizuku YAMADA, Susono-shi (JP); Masaki ITO, Toyota-shi (JP); Sakiko YOSHIDA, Mishima-shi (JP); Yuki TAKAHASHI, Susono-shi (JP); Tomonori IMAMURA, Nagoya-shi (JP)

(73) Assignee: TOYOTA JIDOSHA KABUSHIKI KAISHA, Toyota-shi (JP)

(21) Appl. No.: 17/370,537

(22) Filed: Jul. 8, 2021

(30) Foreign Application Priority Data
Oct. 14, 2020 (JP) 2020-173567

(51) Int. Cl. B60L 53/60; H02J 50/10; H02J 3/00

(52) U.S. Cl. CPC B60L 53/60; H02J 3/0012; H02J 50/10

(57) ABSTRACT

A first aspect of the present disclosure relates to a disaster-stricken area specification device including a processor configured to determine whether or not a disaster occurs at a place where power feed to a target to be charged is performed, based on power feed efficiency by noncontact charging to the target to be charged.

### CROSS-REFERENCE TO RELATED APPLICATION

This application claims priority to Japanese Patent Application No. 2020-173567 filed on Oct. 14, 2020, incorporated herein by reference in its entirety.

### BACKGROUND

### 1. Technical Field

The present disclosure relates to a disaster-stricken area specification device, a disaster-stricken area specification program, and a disaster-stricken area specification system.

### 2. Description of Related Art

Japanese Unexamined Patent Application Publication No. 2011-075386 (JP 2011-075386 A) discloses a technique regarding disaster prediction for recognizing a risky area in a flood disaster. In the technique described in JP 2011-075386 A, a degree of risk is calculated based on a soil water index measured in a district set in advance.

### SUMMARY

Note that, in performing the disaster prediction disclosed in JP 2011-075386 A, there is a need to introduce new equipment, such as a device that measures a soil water amount, for each district. New equipment is needed as a district decreases in area to predict a risky area in detail; however, it may be difficult to provide equipment for all districts.

The present disclosure provides a disaster-stricken area specification device, a disaster-stricken area specification program, and a disaster-stricken area specification system capable of specifying a disaster-stricken area without introducing new equipment.

A first aspect of the present disclosure relates to a disaster-stricken area specification device including a processor configured to determine whether or not a disaster occurs at a place where power feed to a target to be charged is performed, based on power feed efficiency by noncontact charging to the target to be charged.

A second aspect of the present disclosure provides a disaster-stricken area specification program causing a processor execute determining whether or not a disaster occurs at a place where power feed to a target to be charged is performed, based on power feed efficiency by noncontact charging to the target to be charged.

A third aspect of the present disclosure relates to a disaster-stricken area specification system including a power feed management device and a disaster-stricken area specification device. The power feed management device has a first processor configured to calculate power feed efficiency of noncontact charging to a target to be charged based on a remaining amount of stored power of the target to be charged at a first time at which power feed to the target to be charged is started and a remaining amount of stored power of the target to be charged at a second time earlier than the first time. The disaster-stricken area specification device has a second processor configured to determine whether or not a disaster occurs at a place where the power feed to the target to be charged is performed, based on power feed efficiency for the target to be charged.

According to the aspects of the present disclosure, it is possible to specify a disaster-stricken area without introducing new equipment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a disaster-stricken area specification system including a disaster-stricken area specification device according to an embodiment;

FIG. 2 is a block diagram illustrating the configuration of a vehicle (vehicle control device) according to the embodiment;

FIG. 3 is a diagram showing an example of vehicles and traveling lanes in the disaster-stricken area specification system including the disaster-stricken area specification device according to the embodiment;

FIG. 4 is a sequence diagram illustrating disaster-stricken area specification processing that is executed by the disaster-stricken area specification system according to the embodiment; and

FIG. 5 is a schematic view showing a disaster-stricken area specification system according to a modification example.

### DETAILED DESCRIPTION OF EMBODIMENTS

Hereinafter, an embodiment of the present disclosure will be described referring to the drawings. In all drawings of the following embodiment, the same or corresponding portions are represented by the same reference numerals. The present disclosure is not limited to the embodiment described below.

### Embodiment

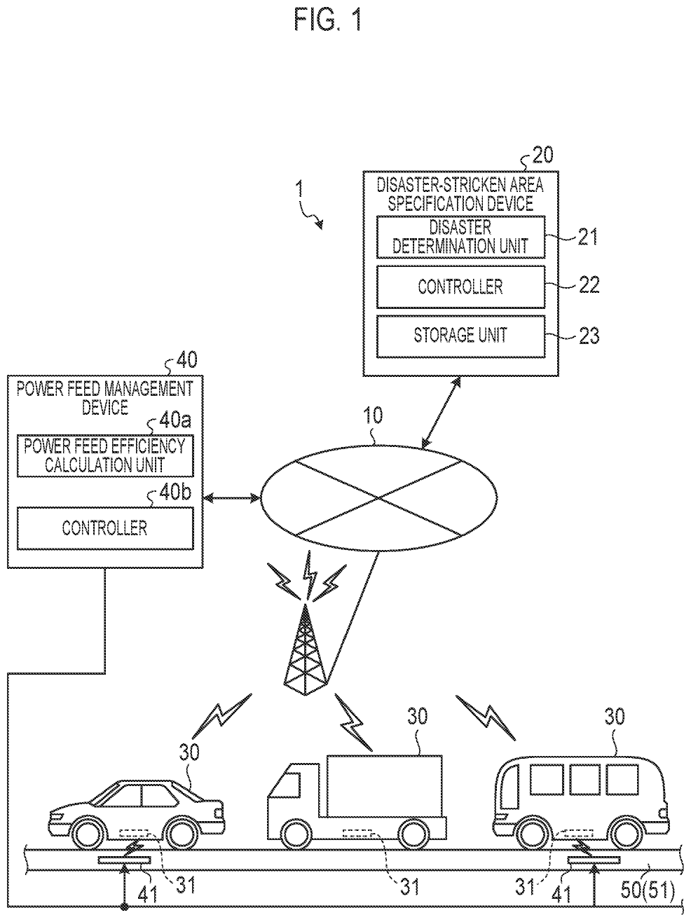

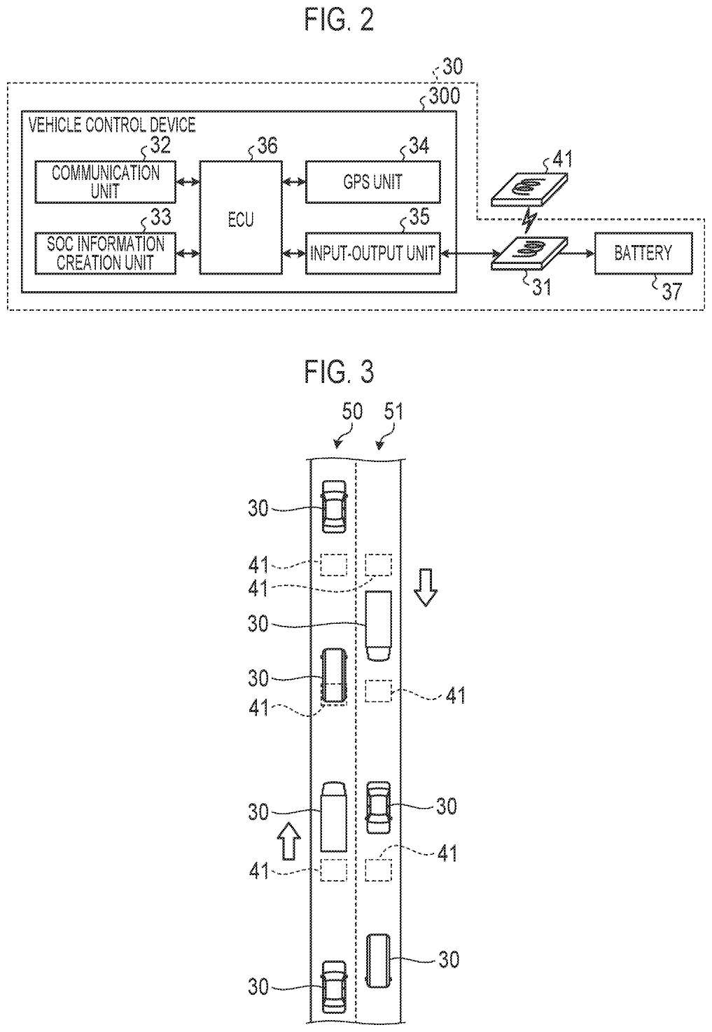

First, a disaster-stricken area specification system including a disaster-stricken area specification device according to an embodiment will be described. FIG. 1 is a schematic view showing the disaster-stricken area specification system including the disaster-stricken area specification device according to the embodiment. FIG. 2 is a block diagram illustrating the configuration of a vehicle (vehicle control device) according to the embodiment. FIG. 3 is a diagram showing an example of vehicles and traveling lanes in the disaster-stricken area specification system including the disaster-stricken area specification device according to the embodiment.

As shown in FIG. 1, a disaster-stricken area specification system 1 according to the embodiment includes a disaster-stricken area specification device 20, vehicles 30, and a power feed management device 40. In the disaster-stricken area specification system 1 according to the embodiment, the disaster-stricken area specification device 20, each vehicle 30, and the power feed management device 40 are connected in a communicable manner by a network 10. The network 10 is constituted of the Internet network, a mobile phone network, or the like through which the disaster-stricken area specification device 20, the vehicle 30, and the power feed management device 40 can perform communication with each other. In the embodiment, it is assumed that the vehicle 30 is a vehicle that can travel in a hybrid traveling mode or an EV traveling mode. The vehicle 30 is charged with electric power that is supplied from a power feed device 41 managed by a power feed management device 40.

The disaster-stricken area specification device 20 receives information regarding power feed from the power feed management device 40 to each vehicle 30, determines whether or not a disaster occurs at a power feed place based on the received information, and specifies a disaster-stricken area. The disaster-stricken area specification device 20 sends disaster information to, for example, a local center or the like that has control over a place where a disaster is specified.

The disaster-stricken area specification device 20 includes a disaster determination unit 21, a controller 22, and a storage unit 23. The disaster-stricken area specification device 20 is constituted using one or a plurality of computers including a central processing unit (CPU), a field programmable gate array (FPGA), a read only memory (ROM), a random access memory (RAM), and the like.

The disaster determination unit 21 determines whether or not a disaster occurs in an area managed by the power feed management device 40, based on power feed efficiency acquired from the power feed management device 40.

Here, in a case where deposits are deposited on a traveling lane and the deposits are interposed between the vehicle 30 and the power feed device 41, the intensity of an electromagnetic wave decreases, and the decrease in intensity causes a decrease in power feed efficiency. Examples of the deposits include liquid, such as water, ice (snow), earth and sand, volcanic ash, and collapsed structures. In this case, a plurality of threshold values may be set depending on a degree of decrease of power feed efficiency and a degree of disaster based on each threshold value, or in a case where a decrease rate of the power feed efficiency is different between the deposits, the threshold value may be set for each deposit. When the threshold value is set depending on a type of a deposit, the disaster determination unit 21 compares the power feed efficiency with each threshold value to determine the type (for example, flood) of the disaster.

The controller 22 integrally controls the operation of each unit of the disaster-stricken area specification device 20.

The storage unit 23 is constituted using a computer readable recording medium, and is configured in such a manner that various programs and various kinds of data are writable and readable. The recording medium is constituted of a storage medium, such as an optical disc, a flash memory, or a magnetic disk, and a drive device of the storage medium.

The storage unit 23 stores the threshold value that is used when the disaster determination unit 21 determines the presence or absence of the occurrence of a disaster. The threshold value is, for example, a lower limit value of the power feed efficiency that is set based on the decrease rate of the power feed efficiency due to the deposit. A plurality of threshold values may be set for each model of the power feed device 41 or a plurality of threshold values may be set based on the decrease rates of the power feed efficiency due to the types of the deposits.

The intensity of the electromagnetic wave may be increased depending on the deposits or the like. When it is assumed that the power feed efficiency is abnormally increased due to such deposits, an upper limit value may be set for the threshold value, and the disaster determination unit 21 may determine that a disaster occurs when a value of the power feed efficiency exceeds the upper limit value.

In the embodiment, noncontact charging is performed between the vehicle 30 and the power feed device 41. A power feed signal is supplied to the vehicle 30 through communication between a transceiver 31 provided in the vehicle 30 and the power feed device 41 connected to the power feed management device 40. For example, each of the transceiver 31 and the power feed device 41 is constituted using a coil, a switching circuit, and a rectifying and smoothing circuit, and transmits and receives the power feed signal by a magnetic resonance system. With this, the vehicle 30 and the power feed device 41 perform communication in a noncontact state. In the embodiment, although an example where power feed and information transmission are performed using the electromagnetic wave has been described, a configuration may be made in which power feed and information transmission are performed using light.

The transceiver 31 transmits a remaining amount of stored power of a battery of the vehicle 30 and a time at which the remaining amount of stored power is acquired, to the power feed device 41. For example, a remaining amount of stored power at a time at which power feed is started by the power feed device 41 and a remaining amount of stored power at a time at which power feed ends are transmitted to the power feed management device 40 by way of the power feed device 41. The remaining amount of stored power is, for example, a state of charge (SOC). Hereinafter, a case where the SOC is used as the remaining amount of stored power will be described.

The power feed device 41 is provided in a traveling lane where power feed to the vehicle 30 is performed, among a plurality of lanes (traveling lanes) on which the vehicles travel, and is electrically connected to the power feed management device 40. In the embodiment, the power feed device 41 has a detection function of detecting the vehicle 30 positioned on the power feed device 41 or a reception function of receiving information of the vehicle 30. The detection function and the reception function are constituted using, for example, a loop antenna. For example, the detection function transmits a detection signal to the power feed management device 40 when the vehicle 30 is detected. In a case where the vehicle can be detected by a coil for power feed, or the like, the coil may be used for power feed and for detection in common.

Subsequently, the configuration of the vehicle 30 will be described referring to FIG. 2. The vehicle 30 includes the transceiver 31, a communication unit 32, an SOC information creation unit 33, a global positioning system (GPS) unit 34, an input-output unit 35, and an electronic control unit (ECU) 36. The vehicle 30 is provided with a battery 37 that supplies electric power to each unit. The battery 37 is configured to be chargeable.

In the embodiment, communication unit 32, the SOC information creation unit 33, the GPS unit 34, the input-output unit 35, and the ECU 36 constitute a vehicle control device 300. The vehicle control device 300 is constituted using one or a plurality of computers including a CPU, an FPGA, a ROM, a RAM, and the like.

The transceiver 31 functions as a receiver that receives the power feed signal from the power feed device 41, and functions as an acquisition unit that acquires energy from the power feed device 41 and a transmission unit that transmits information of the host vehicle to the power feed device 41 in a form of being carried on an electromagnetic wave. The acquisition unit that acquires energy from the power feed device 41 and the transmission unit that transmits information of the host vehicle to the power feed management device 40 may be provided separately, not integrally.

The communication unit 32 performs communication with the disaster-stricken area specification device 20 by wireless communication through the network 10. The communication unit 32 receives driving assistance information for assisting driving of the vehicle 30 from the disaster-stricken area specification device 20. The driving assistance information includes road traffic information, such as regulations or congestion. The communication unit 32 may be configured to transmit information of the host vehicle to the power feed management device 40.

The SOC information creation unit 33 creates SOC information that is transmitted to the power feed management device 40. The SOC information includes at least the SOC of the battery 37 associated with a time. In addition, the SOC information may include a vehicle model, weight, positional information of the vehicle 30, and the like. The SOC information creation unit 33 outputs the created SOC information to the transceiver 31.

The power feed signal received by the transceiver 31 is supplied as electric power to the battery 37.

The GPS unit 34 receives radio waves from GPS satellites to detect a position of the vehicle 30. The detected position is output to the outside (disaster-stricken area specification device 20) or is stored in a storage unit as the positional information of the vehicle 30.

The input-output unit 35 is constituted of a touch panel display, a speaker, a microphone, and the like. The input-output unit 35 is configured to display text, a figure, or the like on a screen of the touch panel display or to output sound from the speaker to input and output predetermined information, such as information regarding driving assistance, under the control of the ECU 36. The input-output unit 35 is configured to input predetermined information to the ECU 36 when a user or the like of the vehicle 30 operates the touch panel display or produces voice toward the microphone.

The ECU 36 is constituted of an information processing apparatus, such as a microcomputer including a CPU, an FPGA, a ROM, a RAM, and the like. The ECU 36 integrally controls the electrical operation of each unit of the vehicle 30. The ECU 36 is configured to perform arithmetic operation using input data or data stored in advance and a program and output an arithmetic operation result as a control command signal.

Though not shown, the vehicle 30 includes a storage unit including a storage medium, such as a hard disk or a semiconductor memory, and a drive device of the storage medium, a sensor that detects an object approaching a forward movement side, and the like. The storage unit stores an operating system (OS) needed when the ECU 36 integrally controls the operation of each unit of the vehicle 30, and programs of various applications.

The vehicle 30 includes a control mechanism and an operation mechanism for driving the vehicle 30. Specifically, the vehicle 30 includes a powertrain and drive wheels as a drive mechanism. The powertrain includes a power source that generates drive power and outputs the drive power from an output shaft, and a power transmission mechanism that transmits the drive power output from the power source to the drive wheels.

The operation mechanism is constituted of a shift lever, an accelerator pedal, and the like.

When autonomous driving of the vehicle 30 is performed, each unit is driven in compliance with an instruction signal under the control of the ECU 36.

The power feed management device 40 is connected to the power feed device 41, and the power feed device 41 receives information acquired from each vehicle 30 and controls power feed to the vehicle 30 based on the received information. The power feed management device 40 is constituted using one or a plurality of computers including a CPU, an FPGA, a ROM, a RAM, and the like. The power feed device 41 outputs acquired transmission information to the power feed management device 40.

The power feed management device 40 includes a power feed efficiency calculation unit 40a and a controller 40b.

The power feed efficiency calculation unit 40a calculates a power feed rate (power feed efficiency) per unit time based on the SOC acquired from the vehicle 30 as a target of power feed. The power feed efficiency calculation unit 40a can employ a known power feed efficiency calculation method.

The controller 40b integrally controls the operation of each unit of the power feed management device 40.

Here, for the power feed device 41, for example, lanes (lanes 50, 51 shown in FIG. 3) with traveling directions opposite to each other are set as power feed lanes. A plurality of power feed devices 41 is provided in the power feed lanes at intervals set in advance. The power feed devices 41 are provided at intervals of several km, for example, in a section of tens of km.

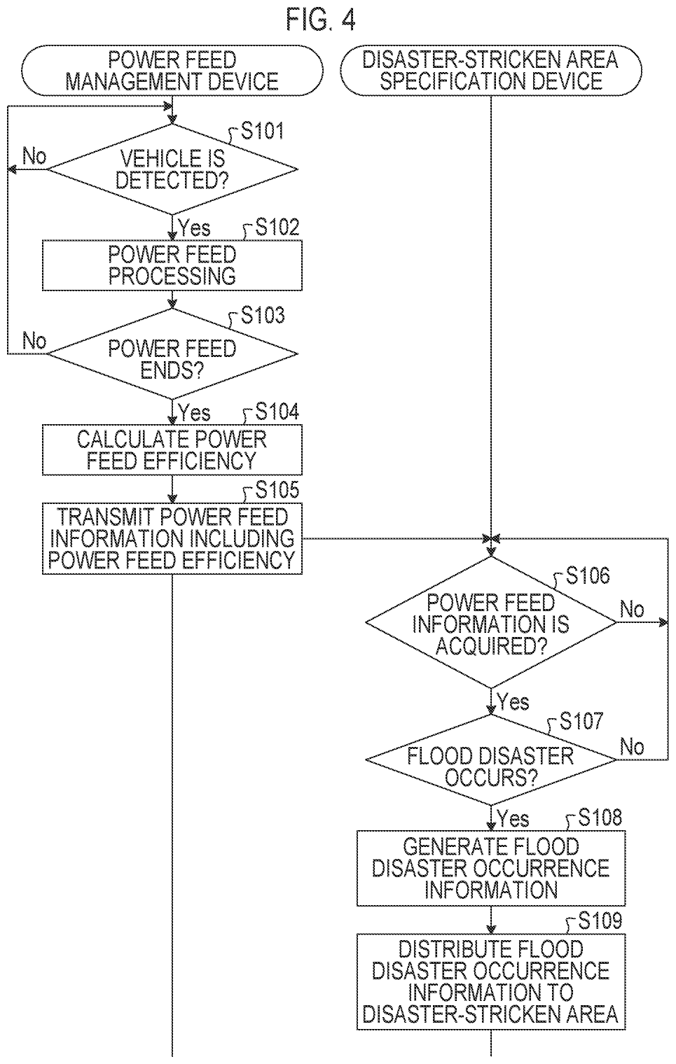

Subsequently, disaster-stricken area specification processing that is executed by the disaster-stricken area specification system 1 will be described referring to FIG. 4. FIG. 4 is a sequence diagram illustrating disaster-stricken area specification processing that is executed by the disaster-stricken area specification system according to the embodiment. In FIG. 4, processing of determining the presence or absence of the occurrence of a flood disaster will be described.

First, the power feed management device 40 detects the vehicle 30 on the power feed device 41 (Step S101). In a case where the vehicle 30 passes over the power feed device 41, the power feed management device 40 receives a detection signal from the power feed device 41. The power feed management device 40 detects the vehicle 30 with the reception of the detection signal. The power feed management device 40 determines the presence or absence of the reception of the detection signal regularly. When determination is made that the detection signal is not received (Step S101: No), the power feed management device 40 repeatedly confirms the reception of the detection signal. In contrast, when the detection signal is received (Step S101: Yes), the power feed management device 40 progresses to Step S102.

In Step S102, the power feed management device 40 supplies electric power to the power feed device 41 that detects the vehicle 30, to execute power feed processing from the power feed device 41 to the vehicle 30. In this case, the power feed management device 40 may constantly supply electric power to the power feed device 41. In Step S102, the power feed management device 40 acquires an SOC at the time of a start of power feed along with a start time through, for example, the power feed device 41.

In Step S103, in a case where detection is made that the vehicle 30 is separated from the power feed device 41, the power feed management device 40 ends the power feed processing (Step S103). Specifically, when a new detection signal is received within a predetermined time from a previous detection signal, the power feed management device 40 determines to continue charging (Step S103: No). In contrast, when the new detection signal is not received for the predetermined time from the previous detection signal, the power feed management device 40 determines to end charging (Step S103: Yes), and progresses to Step S104. The power feed management device 40 acquires an SOC at the time of an end of power feed along with an end time through, for example, the power feed device 41 in progressing to Step S104. The SOC at the time of the start of power feed and the SOC at the time of the end of power feed may be collectively transmitted to the power feed management device 40 in the progress to Step S104.

In Step S104, the power feed efficiency calculation unit 40a calculates power feed efficiency. For example, an SOC at a time immediately before power feed and an SOC at a time immediately after the end of power feed are acquired from the vehicle 30 as a target of power feed. The power feed efficiency calculation unit 40a calculates the power feed rate (an increase rate of the SOC) per unit time based on the acquired time and the SOC and sets the power feed rate as the power feed efficiency. In this case, when power feed is performed over a period during which the vehicle 30 is detected, a charging end time is an end time of a period during which the vehicle 30 travels within a power feed range of the power feed device 41, and when the SOC reaches an upper limit value within the period during which the vehicle 30 is detected (before the vehicle 30 passes through the power feed range), the charging end time is a time at which the SOC reaches the upper limit value. When the power feed efficiency immediately after charging starts is unstable, an SOC at a time several seconds after the power feed starts may be acquired. The SOC is not limited to the SOC at the time of the end of the power feed, and may be an SOC when a time suitable for calculating the power feed efficiency has elapsed from the start time of the power feed. The power feed efficiency calculation unit 40a may calculate the power feed efficiency based on an SOC several seconds after the start time of the power feed and an SOC several seconds before the end time of the power feed.

In Step S105, the power feed management device 40 transmits power feed information including the calculated power feed efficiency to the disaster-stricken area specification device 20. The power feed information includes, in addition to the power feed efficiency, information regarding a position of the power feed device 41 as a target of power feed efficiency calculation.

When the power feed information is received (Step S106: Yes), the disaster-stricken area specification device 20 progresses to Step S107. In a case where the power feed information is not received (Step S106: No), the disaster-stricken area specification device 20 repeatedly confirms the presence or absence of the reception of the power feed information.

In Step S107, the disaster-stricken area specification device 20 determines the presence or absence of the occurrence of a flood disaster. Specifically, the disaster determination unit 21 determines whether or not a flood disaster occurs at a place that is managed by the power feed management device 40, based on the power feed efficiency acquired from the power feed management device 40. The disaster determination unit 21 estimates a flood disaster-stricken area based on the position (place) of the power feed device 41 as a target of determination.

Specifically, the disaster determination unit 21 compares the power feed efficiency with the threshold value stored in the storage unit 23, and when the power feed efficiency is less than the threshold value, determines that the disaster occurs at a place where the power feed device 41 that performs the power feed is provided or in an area including the place. The disaster determination unit 21 estimates the disaster-stricken area based on a determination result of each power feed device 41. For example, an area is associated with each place where the power feed device 41 is provided, and when there is a plurality of power feed devices 41 for which determination is made that a disaster occurs, the disaster determination unit 21 sets a combined disaster-stricken area of the areas of the respective power feed devices 41. The disaster-stricken area is specified by a determination result of the disaster determination unit 21.

The disaster determination unit 21 may determine the presence or absence of the occurrence of a disaster depending on the number of power feed devices 41 having the power feed efficiency less than the threshold value or continuity. For example, when determination is made that a disaster occurs on a predetermined number or more of power feed devices 41 among all power feed device 41 managed by the power feed management device 40, the disaster determination unit 21 determines that the disaster occurs in the area managed by the power feed management device 40. When the number (continuous number) of power feed devices 41 for which determination is made that a disaster occurs and the positions of which are adjacent to each other is equal to or greater than a predetermined number, the disaster determination unit 21 determines that the disaster occurs in the area managed by the power feed management device 40. The term “adjacent to each other” used herein refers to adjacent in the same traveling lane or adjacent at the shortest distance over a plurality of traveling lanes.

In Step S108, the disaster-stricken area specification device 20 generates flood disaster occurrence information based on a determination result of the disaster determination unit 21. The disaster-stricken area specification device 20 generates, as the flood disaster occurrence information, information including a flood disaster occurrence area determined by the disaster determination unit 21. When a degree of flood disaster is determined by setting of a threshold value, information regarding the degree of flood disaster is also included in the flood disaster occurrence information.

Thereafter, the disaster-stricken area specification device 20 distributes the flood disaster occurrence information to a local center or the like that manages the flood disaster-stricken area (Step S109). In a case where the flood disaster occurrence information is received, the local center distributes the received information to a local center of the area, gives an warning that the flood disaster occurs, by disaster prevention broadcasting, sets a passage-prohibited area, or stops the operation of the power feed device 41 in the area.

In the embodiment described above, the presence or absence of the occurrence of a disaster is determined using the power feed efficiency of noncontact charging that changes depending on the presence or absence of deposits interposed between the vehicle 30 and the power feed device 41. According to the embodiment, information is acquired from the power feed device 41 that performs power feed to the vehicle 30, and accordingly, the presence or absence of a disaster can be estimated at the position where the power feed device 41 is provided. Therefore, it is possible to specify a disaster-stricken area without introducing new equipment. With this, it is possible to allow a person in charge of an area to specify the occurrence of the disaster without visiting a site. In a case where a difference in decrease rate of the power feed efficiency due to the deposits can be used, it is possible to determine a disaster type, such as a flood disaster or a landslide disaster, and to distribute the disaster to the area.

In the embodiment, the disaster determination unit 21 determines the presence or absence of the occurrence of a disaster depending on the number of power feed devices 41 having the power feed efficiency less than the threshold value or continuity, and accordingly, it is possible to discriminate and determine failure of the power feed device 41 and the occurrence of a disaster. With this, it is possible to more accurately determine the presence or absence of the occurrence of a disaster.

### Modification Example

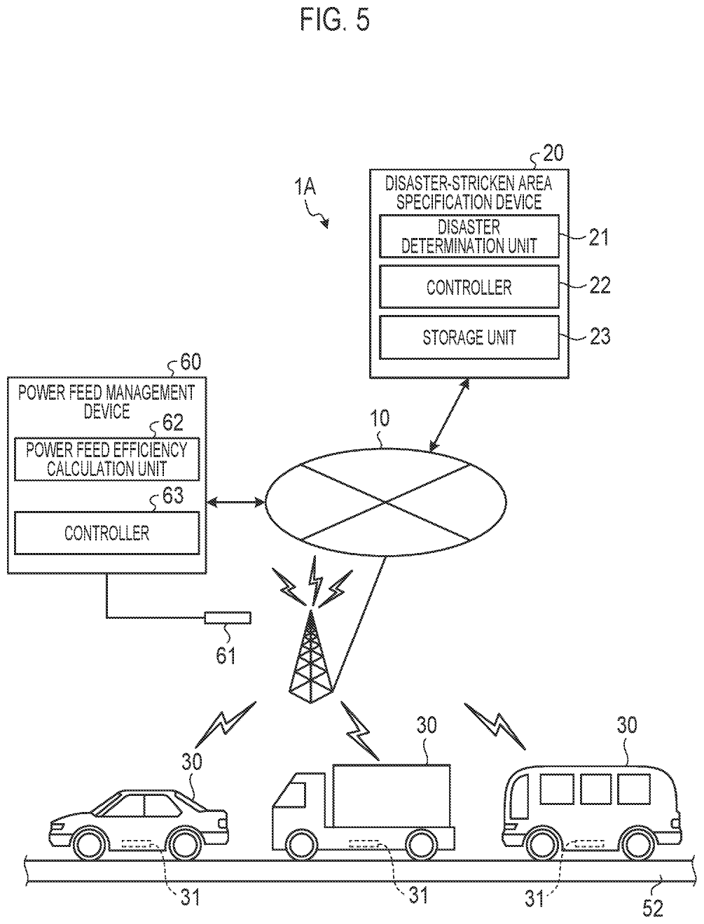

FIG. 5 is a schematic view showing a disaster-stricken area specification system according to a modification example. A disaster-stricken area specification system 1A according to the modification example includes a power feed management device 60 instead of the power feed management device 40 and the power feed device 41 according to the embodiment. Other configurations are the same as those in the disaster-stricken area specification system 1, and thus, description thereof will not be repeated. A power feed device 61 that supplies electric power to the vehicle 30 is connected to the power feed management device 60. The power feed management device 60 has a power feed efficiency calculation unit 62 and a controller 63. In the modification example, an example where the power feed device 41 is not provided in a traveling lane 52 on which the vehicle 30 travels will be described.

The power feed management device 60 is a stationary device, and controls power feed to the vehicle 30 positioned on the power feed device 61. The power feed management device 60 is connected to the disaster-stricken area specification device 20 through the network 10. The power feed management device 60 receives information acquired from the vehicle 30 and controls a line of vehicles based on the received information. The power feed management device 60 is constituted using one or a plurality of computers including a CPU, an FPGA, a ROM, a RAM, and the like.

The power feed device 61 outputs acquired transmission information to the power feed management device 60. The power feed device 61 is constituted of a supply unit that transmits a power feed signal to a transceiver 31 to supply energy, and a receiver that receives information regarding the vehicle 30 from the transceiver 31. The supply unit and the receiver may be provided integrally or separately. The power feed device 61 has a detection function of detecting the vehicle 30 positioned on the power feed device 61. The detection function is constituted using, for example, a loop antenna, and transmits a detection signal to the power feed management device 60 when the vehicle 30 is detected. In a case where the vehicle can be detected by a coil for power feed, or the like, the coil may be used for power feed and for detection in common.

The power feed efficiency calculation unit 62 calculates power feed efficiency in the same manner as the power feed efficiency calculation unit 40a.

The controller 63 integrally controls the operation of each unit of the power feed management device 60.

In the modification example described above, as in the embodiment, a disaster is determined using change in power feed efficiency of noncontact charging that changes depending on the presence or absence of deposits interposed between the vehicle 30 and the power feed device 61. According to the modification example, information is acquired from the power feed device 61 for power feed, and accordingly, the presence or absence of a disaster can be determined. Therefore, it is possible to specify a disaster-stricken area without introducing new equipment.

The embodiment and the modification example may be combined such that the presence or absence of the occurrence of a disaster is determined using information of power feed acquired from both the power feed device provided in the traveling lane and the stationary power feed device.

Recording Medium

In the embodiment, a program that can execute a processing method by the disaster-stricken area specification system can be recorded on a recording medium that is readable by a computer or other machines or devices (hereinafter, referred to as a computer or the like). The program on the recording medium is read to and executed on the computer or the like, whereby the computer or the like functions as the controller of each device of the disaster-stricken area specification system. Here, the recording medium that is readable by the computer or the like refers to a non-transitory recording medium on which information, such as data or programs, can be accumulated by an electrical, magnetic, optical, mechanical, or chemical action and can be read through the computer or the like. Among such recording mediums, examples of recording mediums that are removable from the computer or the like include a flexible disk, a magneto-optical disk, a CD-ROM, a CD-R/W, a digital versatile disk (DVD), a BD, a DAT, a magnetic tape, and a memory card, such as a flash memory. Examples of recording mediums that are fixed in the computer or the like include a hard disk and a ROM. An SSD is available as a recording medium that is removable from the computer or the like or as a recording medium that is fixed in the computer or the like.

### OTHER EMBODIMENTS

In the disaster-stricken area specification system according to the embodiment, a “unit” can be replaced with a “circuit” or the like. For example, the communication unit can be replaced with a communication circuit.

The program that is executed by each device of the disaster-stricken area specification system according to the embodiment may be provided by storing the program on a computer connected to a network, such as the Internet, and downloading the program by way of the network.

Other effects or modification examples can be easily derived by those skilled in the art. Broader aspects of the present disclosure are not limited to specific details and representative embodiments shown and described above. Accordingly, various alterations may be made without departing from the spirit or scope of the general inventive concept defined by the appended claims and equivalents thereof

What is claimed is:

1. A disaster-stricken area specification device comprising a processor configured to determine whether or not a disaster occurs at a place where power feed to a target to be charged is performed, based on power feed efficiency by noncontact charging to the target to be charged.

2. The disaster-stricken area specification device according to claim 1, wherein the processor is configured to determine whether or not the disaster occurs at the place where the power feed to the target to be charged is performed when the power feed efficiency is equal to or less than a threshold value set in advance.

3. The disaster-stricken area specification device according to claim 1, wherein the processor is configured to determine that the disaster occurs at the place where the power feed to the target to be charged is performed when the number of power feed devices having the power feed efficiency equal to or less than a threshold value set in advance is equal to or greater than a predetermined number.

4. The disaster-stricken area specification device according to claim 2, wherein a plurality of the threshold values is set depending on a type of the disaster.

5. The disaster-stricken area specification device according to claim 4, wherein the processor is configured to determine the type of the disaster based on the power feed efficiency and the plurality of threshold values.

6. The disaster-stricken area specification device according to claim 1, wherein the processor is configured to determine presence or absence of occurrence of the disaster based on the power feed efficiency that decreases due to deposits deposited on a lane on which a vehicle travels.

7. A disaster-stricken area specification program causing a processor to execute determining whether or not a disaster occurs at a place where power feed to a target to be charged is performed, based on power feed efficiency by noncontact charging to the target to be charged.

8. The disaster-stricken area specification program according to claim 7, causing the processor to execute determining whether or not the disaster occurs at the place where the power feed to the target to be charged is performed when the power feed efficiency is equal to or less than a threshold value set in advance.

9. The disaster-stricken area specification program according to claim 7, causing the processor to execute distributing, to a local center that has control over the place where determination is made that the disaster occurs, information regarding the determined disaster.

10. The disaster-stricken area specification program according to claim 8, wherein a plurality of the threshold values is set depending on a type of the disaster.

11. The disaster-stricken area specification program according to claim 10, causing the processor to execute determining the type of the disaster based on the power feed efficiency and the plurality of threshold values.

12. The disaster-stricken area specification program according to claim 7, causing the processor to execute determining presence or absence of occurrence of the disaster based on the power feed efficiency that decreases due to deposits deposited on a lane on which a vehicle travels.

13. A disaster-stricken area specification system comprising:
a power feed management device having a first processor configured to calculate power feed efficiency of noncontact charging to a target to be charged based on a remaining amount of stored power of a battery of the target to be charged at a first time at which power feed to the target to be charged starts and a remaining amount of stored power of the battery of the target to be charged at a second time earlier than the first time; and
a disaster-stricken area specification device having a second processor configured to determine whether or not a disaster occurs at a place where the power feed to the target to be charged is performed, based on the power feed efficiency for the target to be charged.

14. The disaster-stricken area specification system according to claim 13, wherein the first processor is configured to acquire the remaining amount of stored power from a power feed device provided in a traveling lane on which a vehicle as the target to be charged travels.

15. The disaster-stricken area specification system according to claim 13, wherein the first processor is configured to acquire the remaining amount of stored power from a power feed device provided near the power feed management device.

16. The disaster-stricken area specification system according to claim 13, wherein the second processor is configured to determine whether or not the disaster occurs at the place where the power feed to the target to be charged is performed when the power feed efficiency is equal to or less than a threshold value set in advance.

17. The disaster-stricken area specification system according to claim 13, wherein the second processor is configured to distribute, to a local center that has control over a place where determination is made that the disaster occurs, information regarding the determined disaster.

18. The disaster-stricken area specification system according to claim 16, wherein a plurality of the threshold values is set depending on a type of the disaster.

19. The disaster-stricken area specification system according to claim 17, wherein the second processor is configured to determine a type of the disaster based on power feed efficiency and a plurality of threshold values.

20. The disaster-stricken area specification system according to claim 13, wherein the second processor is configured to determine presence or absence of occurrence of the disaster based on the power feed efficiency that decreases due to deposits deposited on a lane on which a vehicle travels.
